(19) United States
(12) Patent Application Publication
(10) Pub. No.: US 2011/0141518 A1
(43) Pub. Date: Jun. 16, 2011

(54) INFORMATION DISTRIBUTION APPARATUS, INFORMATION PROCESSING APPARATUS, AND CONTROL METHOD

(75) Inventor: Hiroyuki Kayama, Yokohama-shi (JP)

(73) Assignee: CANON KABUSHIKI KAISHA, Tokyo (JP)

(21) Appl. No.: 12/963,480

(22) Filed: Dec. 8, 2010

(30) Foreign Application Priority Data
Dec. 14, 2009 (JP) 2009-283346

(51) Int. Cl. G06F 3/12

(52) U.S. Cl. 358/1.15

(57) ABSTRACT

In an information distribution apparatus, if an optimum layout of a plurality of printers is calculated and a printer utilization information list is updated, a determination is made for each client to check whether a printer to be used by each client has been changed. Then, if the printer to be used by a client has been changed, the information relating to the client stored in a currently used printer is moved to a newly used printer. Further, notification information relating to the newly used printer (i.e., information including the printer to be used by the client and the print method of the client) is generated for the client and transmitted to the client.

### BACKGROUND OF THE INVENTION

1. Field of the Invention

The present invention relates to a technique that enables users to appropriately use an image forming apparatus based on a calculation result of an optimum layout.

2. Description of the Related Art

As discussed in Japanese Patent Application Laid-Open No. 2004-289642, there is a conventional optimum layout analyzing apparatus that analyzes an optimum layout of a plurality of image forming apparatuses to be located in an office for improving the usability of respective image forming apparatuses.

First, the optimum layout analyzing apparatus discussed in Japanese Patent Application Laid-Open No. 2004-289642 collects utilization history from each image forming apparatus, and accepts a calculation instruction with respect to an optimum layout level (i.e., a numerical value expressing a desired setup location of the image forming apparatus) together with image forming apparatus/client information. Then, the optimum layout analyzing apparatus calculates an optimum layout level based on the collected utilization history and the image forming apparatus/client information, and notifies the calculated optimum layout level to all of respective clients.

Further, according to a technique discussed in Japanese Patent Application Laid-Open No. 2007-55124, if replacement (layout change) or setting change (e.g., change in IP address or configuration) occurs in an image forming apparatus, the same content of changes is sent to each client whose IP address is stored in the image forming apparatus.

However, according to the above-described conventional technique, the layout of the image forming apparatuses is simultaneously notified to all clients. Accordingly, even after a print environment is constructed based on a calculation result of the optimum layout, individual users of respective clients can freely use the image forming apparatuses for printing operations. Therefore, a specific image forming apparatus may be frequently used by many users. Therefore, as a whole, the printing operations cannot be performed efficiently.

For example, it is assumed that one of a plurality of image forming apparatuses is designated as an apparatus to be used by a currently concerned user based on a determined optimum layout of the plurality of image forming apparatuses provided in an office. In this case, if there is another image forming apparatus positioned closely to a desk/seat of the concerned user compared to the designated image forming apparatus to be used by the user, the user may frequently use the image forming apparatus positioned closely to the desk/seat of the user. In other words, the image forming apparatus positioned closely to the desk/seat of the concerned user is frequently used by the concerned user in addition to regularly designated users. Therefore, as a whole, the printing operation cannot be performed efficiently even after the print environment is constructed based on the calculation result of the optimum layout.

Further, the layout of a client computer (i.e., the distance between a client computer and an image forming apparatus) and the frequency of use in the printing operation are variable depending on each user. Therefore, even if the same information (information relating to the layout of respective image forming apparatuses) is notified to all client computers, it is difficult for individual users to obtain necessary information.

### SUMMARY OF THE INVENTION

The present invention relates to a technique capable of prompting individual users to efficiently perform operations according to an optimum layout of image forming apparatuses.

According to an aspect of the present invention, an information distribution apparatus can communicate with information processing apparatuses of a plurality of clients who can use a plurality of image forming apparatuses. The information distribution apparatus includes a storage unit configured to store information relating to the plurality of image forming apparatuses; an updating unit configured to update the information relating to the plurality of image forming apparatuses stored in the storage unit according to an optimum layout of the plurality of image forming apparatuses obtained based on history information collected from the plurality of image forming apparatuses; an analyzing unit configured to analyze an image forming apparatus to be used by each of the plurality of clients according to the optimum layout of the plurality of image forming apparatuses obtained based on the history information collected from the plurality of image forming apparatuses; a generation unit configured to generate, as an analysis result according to the optimum layout, notification information including information relating to the image forming apparatus to be used by each of the plurality of clients and a print method of the client corresponding to the image forming apparatus; and a notification unit configured to send the notification information generated by the generation unit to each of the plurality of information processing apparatuses.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example configuration of an information processing system according to an exemplary embodiment of the present invention.

FIG. 2 is a block diagram illustrating an example configuration of an information processing apparatus according to an exemplary embodiment of the present invention.

FIG. 3 illustrates a memory map of a random access memory (RAM) according to an exemplary embodiment of the present invention.

FIG. 4 illustrates a memory map of a flexible disk according to an exemplary embodiment of the present invention.

FIG. 5 illustrates a module configuration of an optimum layout control program according to an exemplary embodiment of the present invention.

FIGS. 6A and 6B illustrate examples of a printer utilization information list according to an exemplary embodiment of the present invention.

FIG. 7 illustrates an example of a print method list according to an exemplary embodiment of the present invention.

FIG. 8 illustrates an example of a setup information list according to an exemplary embodiment of the present invention.

FIGS. 9A and 9B illustrate examples of a user interface that can be used to notify a changed print environment according to an exemplary embodiment of the present invention.

FIG. 10 illustrates an example of a user interface that can be used to notify completion of a printing operation according to an exemplary embodiment of the present invention.

FIGS. 11A and 11B illustrate examples of the layout plan view including a plurality of clients and a plurality of printers according to an exemplary embodiment of the present invention.

FIG. 12 is a flowchart illustrating an example of processing that can be performed when the printer utilization information list is updated according to an exemplary embodiment of the present invention.

FIG. 13 (13A and 13B) is a flowchart illustrating details of the processing to be performed in step S1204 according to an exemplary embodiment of the present invention.

FIG. 14 is a flowchart illustrating details of the processing to be performed in step S1205 according to an exemplary embodiment of the present invention.

### DESCRIPTION OF THE EMBODIMENTS

Various exemplary embodiments, features, and aspects of the invention will be described in detail below with reference to the drawings.

<System Configuration>

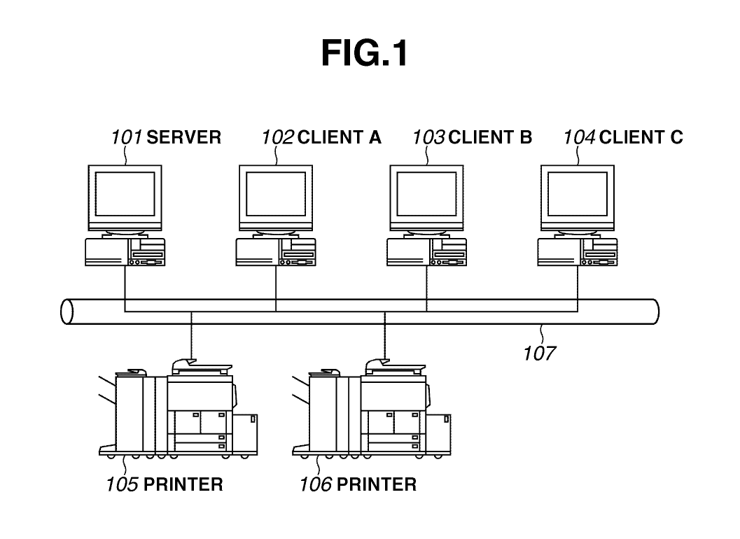

FIG. 1 is a block diagram illustrating an example configuration of an information processing system.

In FIG. 1, a server computer (hereinafter, referred to as a server) 101 is an information processing apparatus that is connected to a network 107 via a network cable such as an Ethernet® cable and is configured to store files to be transmitted and received via the network 107. The server 101 can monitor a utilization state of the network 107, and can manage a plurality of client computers 102 to 104 and network printers 105 and 106 that are connected via the network 107.

The client computers (hereinafter, referred to as “clients”) 102 to 104 are information processing apparatuses that are connected via network cables to the network 107, and can execute various programs including application programs. Each of the clients 102 and 103 has an installed printer driver that is functionally operable to convert print data into printer languages that can be processed by the network printers 105 and 106.

The printer driver can support a plurality of printer drivers. In the following description, as illustrated in FIG. 1, the client 102, the client 103, and the client 104 may sometimes be referred to as client A, client B, and client C.

The server 101 and the clients 102 to 104 are general information processing apparatuses. Each of the clients 102 and 103 and the server 101 stores an optimum layout control program that is executable to perform unique controls. Further, the server 101 has the capability of functioning as a client computer comparable to the clients 102 to 104.

The network printers (hereinafter, referred to as “printers”) 105 and 106 are examples of the image forming apparatus. The printers 105 and 106 are connected to the network 107 via network interfaces (not illustrated). The printers 105 and 106 can analyze print jobs including print data transmitted from the clients 102 to 104 and the server 101, and can convert the print data into dot images on a page-by-page basis to print each page.

The printers 105 and 106 can be selected from various types of printers, including laser beam printers operable according to an electrophotographic method, inkjet printers operable according to an inkjet method, and printers operable according to a heat transfer method.

The network 107 connects the server 101, the clients 102 to 104, and the printers 105 and 106 so that the server 101, the clients 102 to 104, and the printers 105 and 106 can communicate with each other.

The example illustrated in FIG. 1 includes three client computers 102 to 104 and two network printers 105 and 106. However, the number of a plurality of client computers and the number of a plurality of network printers are not limited to the illustrated example.

<Configuration of Information Processing Apparatus>

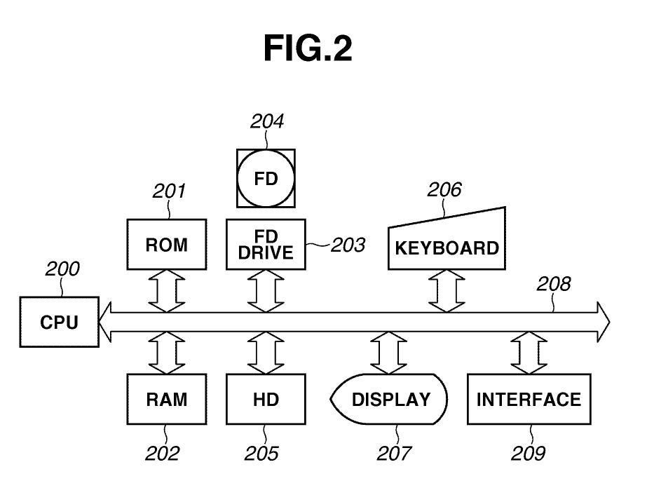

FIG. 2 is a block diagram illustrating an example configuration of the information processing apparatus. The server 101 and the clients 102 to 104 are configured to be functionally operable as an information processing apparatus and have a hardware configuration illustrated in FIG. 2. Therefore, the block diagram illustrated in FIG. 2 represents a hardware configuration of any one of the server 101 and the clients 102 to 104.

In FIG. 2, a central processing unit (CPU) 200 is an example of a control device for the information processing apparatus. The CPU 200 executes application programs, printer driver programs, an operating system (OS), and an optimum layout control program stored in a hard disk (HD) 205, and temporarily stores information and files required in execution of the programs in a random access memory (RAM) 202.

A read only memory (ROM) 201 is an example of a storage device, which stores various programs including a basic I/O program, font data to be used in document processing, template data, and other various data. The RAM 202 is an example of a temporary storage device, which is functionally operable as a main memory or a work area of the CPU 200.

A flexible disk (FD) drive 203 is an example of a storage medium reading device. A program stored in a flexible disk (FD) 204 (i.e., a storage medium) can be loaded into a computer system of the information processing apparatus. The storage medium is not limited to the FD and can be any one of a compact disc-ROM (CD-ROM), a CD-recordable (CD-R), a CD-rewritable (CD-RW), a personal computer (PC) card, a digital versatile disc (DVD (DVD-ROM, DVD-R)), an integrated circuit (IC) memory card, a magneto-optical (MO) disk, and a memory stick. The FD 204 is an example FD that is operable as a storage medium storing computer-readable programs.

The hard disk (HD) 205 is an example of an external storage medium that is functionally operable as a mass storage memory. The HD 205 stores the application programs, the printer driver programs, the operating system (OS), the optimum layout control program, and relevant programs. Further, a spooler (i.e., an example of a spool device) is secured in the HD 205. Further, the HD 205 of the server 101 stores log information collected from the printers 105 and 106 and printer utilization information for each client.

A keyboard 206 is an example of an instruction input device that enables an operator or an administrator of the server 101 to input control commands or enables users of the clients 102 to 104 to input control commands for the printers 105 and 106.

A display 207 is an example of a display device, which can display commands having been input via the keyboard 206 and operational states of the printers 105 and 106. A system bus 208 can regulate the flow of data in each of the server 101 and the clients 102 to 104 (i.e., information processing apparatuses (computers)). An interface 209 is an example of an input/output unit via which the information processing apparatus transmits and receives data to and from an external apparatus.

<Memory Map>

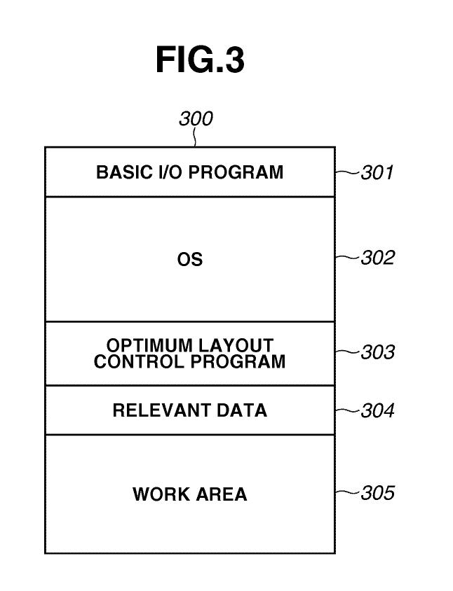

FIG. 3 illustrates an example of a memory map of the RAM 202 illustrated in FIG. 2. The memory map illustrated in FIG. 3 is in a state where the optimum layout control program is loaded from the FD 204 to the RAM 202 and is executable.

In the present exemplary embodiment, the optimum layout control program and relevant data are directly loaded from the FD 204 to the RAM 202, and can be executed by the CPU 200. Alternatively, it is useful to load the optimum layout control program from the HD 205 to the RAM 202, if the optimum layout control program is already installed, every time when the optimum layout control program is operated from the FD 204.

Further, the medium storing the optimum layout control program is not limited to the above-described FD and can be any one of a CD-ROM, a CD-R, a PC card, a DVD, and an IC memory card. Further, the optimum layout control program can be stored in the ROM 201 so as to constitute a part of the memory map and can be directly executed by the CPU 200. Moreover, the hardware configuration of each of the above-described apparatuses can be realized by a software configuration capable of realizing a similar function.

A basic I/O program 301 is an area where a program having an initial program loading (IPL) function is present. The IPL program loads an operating system (OS) 302 into the RAM 202 from the HD 205 when a power source of the information processing apparatus is turned on and causes the OS 302 to start its operation.

An optimum layout control program 303 is stored in an area secured in the RAM 202. Relevant data 304 is stored in an area secured in the RAM 202. A work area 305 secures an area where the CPU 200 executes the optimum layout control program 303.

The optimum layout control program 303 provided in the server 101 collects log information (utilization history) from the printers 105 and 106, and calculates an optimum layout of the printers 105 and 106 based on the collected log information. Further, the optimum layout control program 303 notifies the clients 102 and 103 of a change with respect to a print destination printer. The optimum layout control program 303 provided in respective clients 102 to 104 includes a control program that can instruct changes in printer driver settings.

The optimum layout control program 303, which performs the above-described control, can be separated into a module to be installed in the server 101 and a module to be installed in respective clients 102 to 104. Further, one optimum layout control program may selectively function as a program dedicated to a specific client or a program dedicated to the server depending on its operational environment.

Further, a client dedicated module and a server dedicated module can be installed together on the same information processing apparatus (i.e., the same computer). These modules can be configured to be simultaneously operable or perform a time-divisional or pseudo parallel operation.

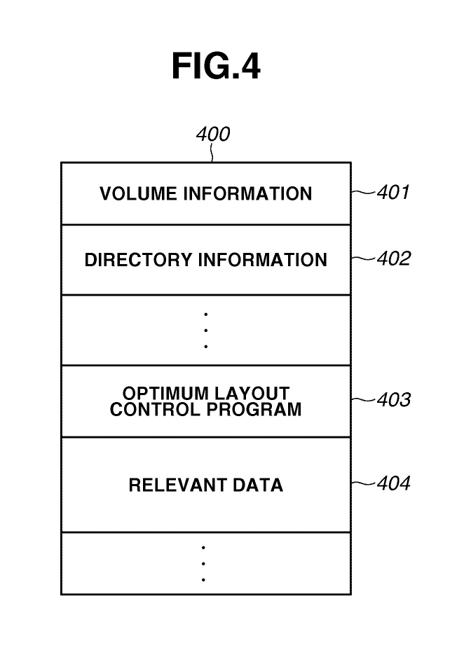

FIG. 4 illustrates an example of the memory map for the FD 204 illustrated in FIG. 2. As illustrated in FIG. 4, the FD 204 stores information data 400 including volume information 401, directory information 402, optimum layout control program 403, and relevant data 404. The optimum layout control program 403 is a program having been programmed according to the following flowchart.

<Module Configuration of Print Control Program>

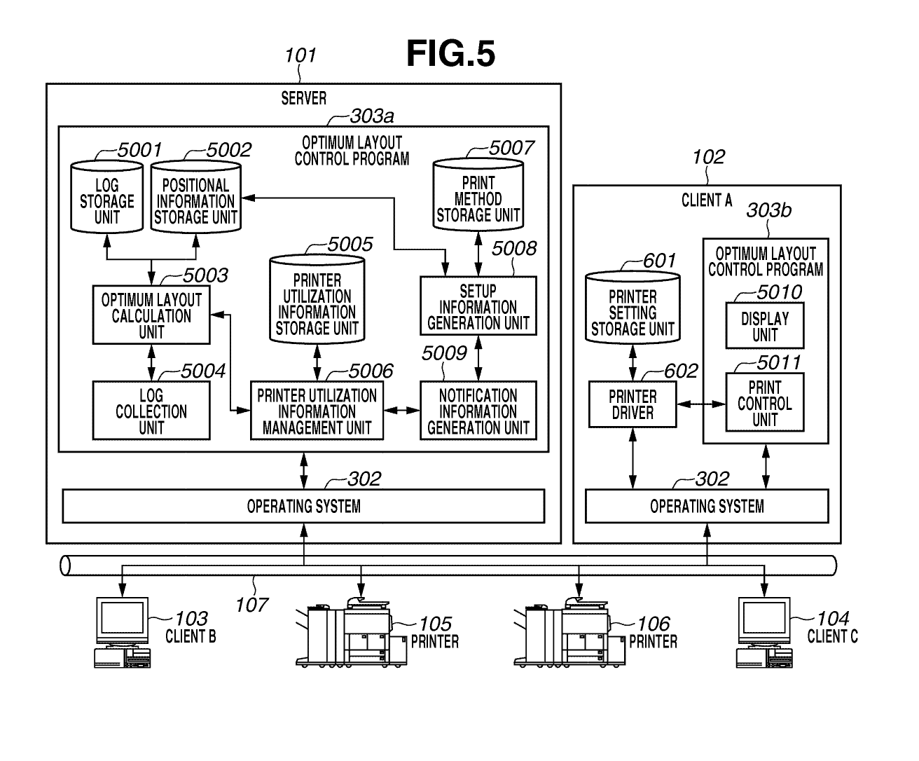

FIG. 5 illustrates an example module configuration of the optimum layout control program 303 in the server 101 and the client 102. The optimum layout control program 303 is stored in the HD 205. The CPU 200 can execute the optimum layout control program 303 when it is loaded into the RAM 202. The optimum layout control program 303 provided in respective clients 103 and 104 is similar to that provided in the client 102 in the module configuration, although not described below.

The server 101 includes a log storage unit 5001 that stores printer utilization history of respective clients 102 to 104 and a log collection unit 5004 that collects the printer utilization history of respective clients 102 to 104 from the printers 105 and 106. The printer utilization history includes print history. The utilization history (history information) may include operation history and copy/facsimile history in addition to the print history. An optimum layout calculation unit 5003 can calculate an optimum layout of the printers 105 and 106 based on the information stored in the log storage unit 5001.

The server 101 further includes a positional information storage unit 5002 that stores positional information of the clients 102 to 104 and the printers 105 and 106. The positional information stored in the positional information storage unit 5002 includes information to be used in calculation of relative distances between the server 101, the clients 102 to 104, and the printers 105 and 106. Further, the positional information storage unit 5002 stores a layout plan view that illustrates a positional relationship among the server 101, the clients 102 to 104, and the printers 105 and 106.

The optimum layout calculation unit 5003 provided in the server 101 calculates the optimum layout of the printers 105 and 106 based on the log information stored in the log storage unit 5001 and the positional information stored in the positional information storage unit 5002. An algorithm to be used in calculation of the optimum layout can be appropriately employed.

The log collection unit 5004 provided in the server 101 collects the printer utilization history of respective clients 102 to 104 from the printers 105 and 106. As described above, the printer utilization history may include operation history and copy/facsimile history in addition to the print history.

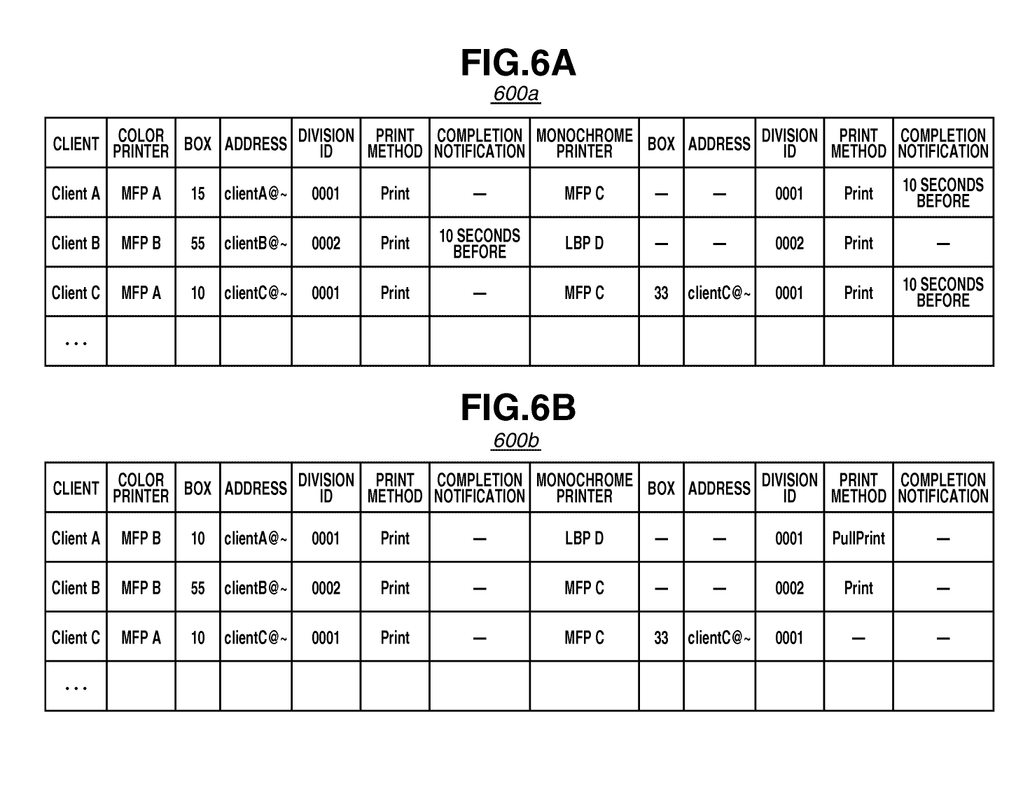

The server 101 further includes a printer utilization information storage unit 5005 that stores printer utilization information lists 600a and 600b illustrated in FIGS. 6A and 6B. Printers to be used for each of the clients 102 to 104 and client information managed in respective printers are recorded in the printer utilization information lists 600a and 600b.

The client information, which is dependent on each client, includes an address of the client to be referred to in transmission of data and a BOX number that stores a print job including print data. The printer utilization information lists 600a and 600b are described below in more detail. Further, information (e.g., IP address (or any other network information) and setup location) relating to a plurality of printers to be managed are stored and managed.

The server 101 further includes a printer utilization information management unit 5006 that manages generation and update of the printer utilization information lists 600a and 600b. The printer utilization information management unit 5006 analyzes a printer to be used based on the optimum layout calculated by the optimum layout calculation unit 5003 and generates/updates the printer utilization information list 600. The printer utilization information management unit 5006 sends a notification informing the updated information, if the printer utilization information list 600 is updated, to the notification information generation unit 5009.

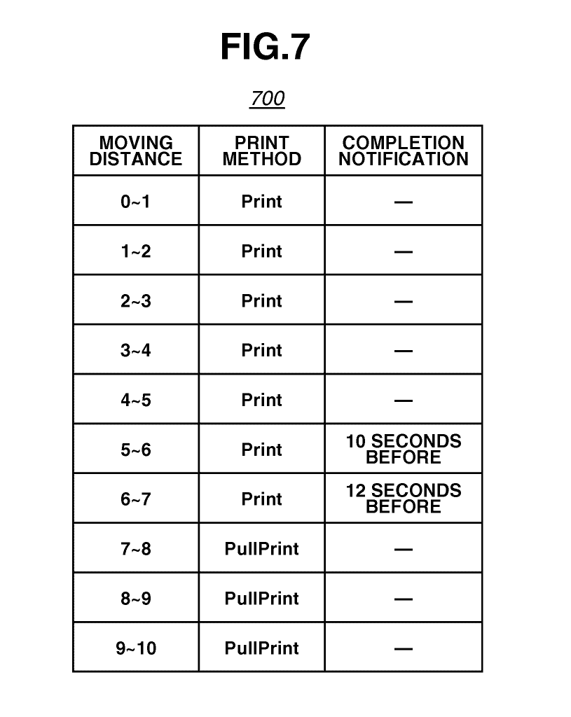

The server 101 further includes a print method storage unit 5007 that stores a print method list 700 illustrated in FIG. 7, which can be used to determine a print method and print completion notification timing in each client. A setup information generation unit 5008 can manage the print method list 700. The setup information generation unit 5008 can display a user interface (not illustrated) that enables users to set the print method list 700.

The print method list 700 includes settings with respect to the print method (Print/Pull Print) and the print completion notification timing that are variable depending on the moving distance of a user in each client. The moving distance of a user in each client represents the distance between the client of the user and the printer.

Further, “Pull Print” represents a print method according to which a printer executes printing of print data acquired from a client in response to a user's operation performed on an operation unit of the printer. Further, “Print” represents a print method according to which a printer executes printing of print data transmitted from a client in response to a user's operation input at a client.

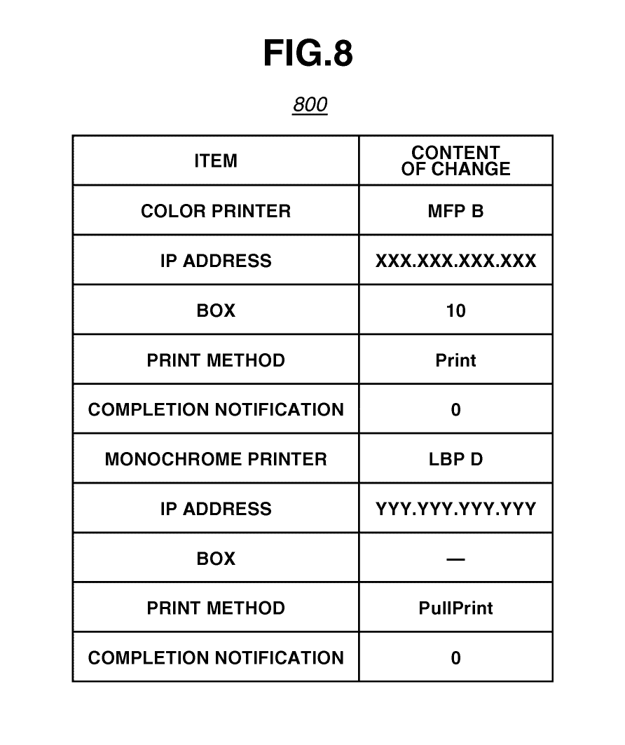

The setup information generation unit 5008 provided in the server 101 generates a setup information list 800 illustrated in FIG. 8 according to an instruction from the notification information generation unit 5009. The setup information list 800 includes setting information to be referred to when the settings of a printer driver are updated in a client. The setup information list 800 includes information relating to an output destination printer, such as “IP address information, BOX number, print method, and print completion notification timing.”

The notification information generation unit 5009 provided in the server 101 receives a notification informing a change in the printer to be used in a client from the printer utilization information management unit 5006, and performs information distribution processing for notifying the target client of the change in the printer to be used.

The notification information to be sent to the target client includes printer name (color printer/monochrome printer), BOX number (BOX), print method, and print completion notification timing (completion notification) that are described in the printer utilization information list 600. The notification information to be sent to the target client further includes the positional information (e.g., a layout plan view) stored in the positional information storage unit 5002 and the setup information list 800 generated by the setup information generation unit 5008.

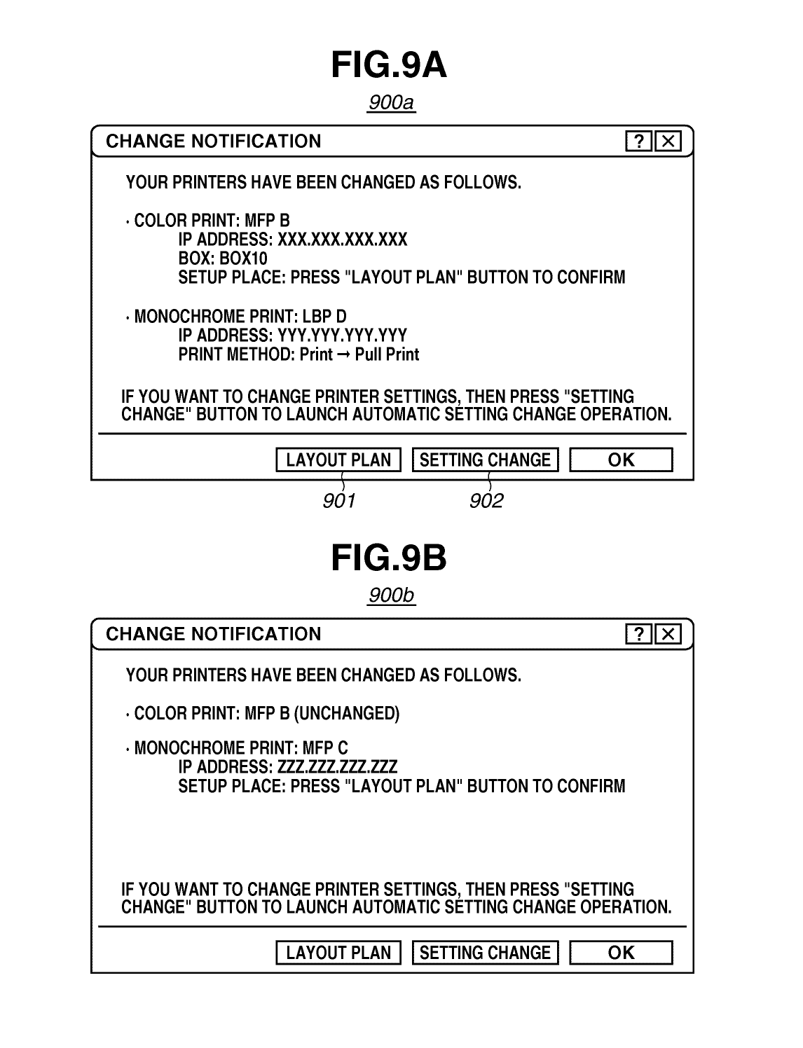

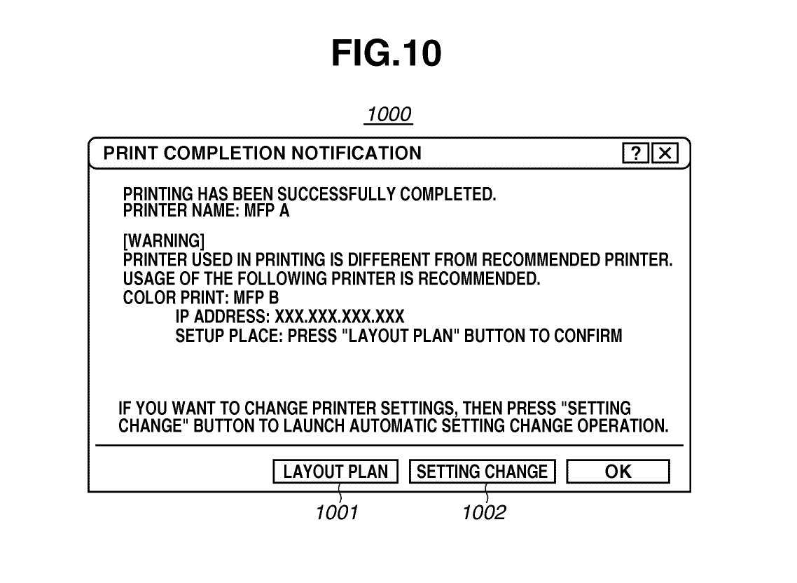

The client 102 includes a display unit 5010 that can display change information and print completion relating to a printer to be used. The display unit 5010 can display user interfaces 900a and 900b illustrated in FIGS. 9A and 9B based on information generated by the notification information generation unit 5009 of the server 101. Further, the client 102 includes a print control unit 5011 that detects completion of a printing operation by tracking a print job including print data. The display unit 5010 can display a user interface 1000 illustrated in FIG. 10 to notify a user of the client 102 of the detected completion of a printing operation.

The print control unit 5011 provided in the client 102 can control a printing operation. The print control unit 5011 can track print jobs transmitted from the client 102 to the printers 105 and 106, and can update printer driver settings (i.e., print environment) stored in a printer setting storage unit 601. The printer driver settings stored in the printer setting storage unit 601 can be updated based on the information of the setup information list 800 generated by the setup information generation unit 5008 of the server 101.

The printer setting storage unit 601 provided in the client 102 stores printer driver settings that are required when the printers 105 and 106 perform printing. More specifically, the printer setting storage unit 601 stores printer configuration (e.g., IP address) and default print settings (e.g., print method, number of copies, and printing format).

The client 102 further includes a printer driver 602 that can manage a printer when it is read into a memory of the client 102. In the present exemplary embodiment, the printer driver 602 generates a print job that can be processed by the printer based on the printer driver settings stored in the printer setting storage unit 601, transmits the generated print job to the printer, and requests a formation of an image.

<Printer Utilization Information List>

FIGS. 6A and 6B illustrate examples of the printer utilization information lists 600a and 600b, which are stored in the printer utilization information storage unit 5005 of the server 101.

The printer utilization information lists 600a and 600b include names of the color printers/monochrome printers to be used by respective clients 102 to 104 and client information managed in respective printers. In FIGS. 6A and 6B, the names of the color printers/monochrome printer are stored in a color printer field or a monochrome printer field.

Further, the client information includes BOX information (BOX number) that is used by a target client, address information required when printer data is transmitted to the target client, and ID information of a division to which the target client belongs. The division ID can be referred to in counting printed sheets for each division and in an access control in each division.

The client information further includes print method and print completion notification timing information having been set for each target client. The print completion notification timing information indicates notification timing that precedes the completion of a printing operation (i.e., how many seconds before the completion of a printing operation). In the printer utilization information lists 600a and 600b, respective data representing BOX number, address information, division ID, print method, and print completion notification timing are stored in BOX, address, division ID, print method, and completion notification fields, respectively.

The printer utilization information management unit 5006 generates and updates the printer utilization information lists 600a and 600b based on the optimum layout calculated by the optimum layout calculation unit 5003. More specifically, the printer utilization information management unit 5006 generates and updates the printer utilization information lists 600a and 600b based on the print history and the optimum layout calculated by the optimum layout calculation unit 5003, so that the moving distances of all clients and printer loads can be minimized (or averaged). An algorithm to be used in generating/updating the printer utilization information list 600 can be appropriately employed.

Further, the print method and the print completion notification timing described in the printer utilization information list 600 can be appropriately set based on the setup information list 800 generated by the setup information generation unit 5008. The printer utilization information management unit 5006 may enable a user to input setting data/information with respect to the printer utilization information list 600 while viewing a user interface (not illustrated) displayed on the display 207 of the server 101.

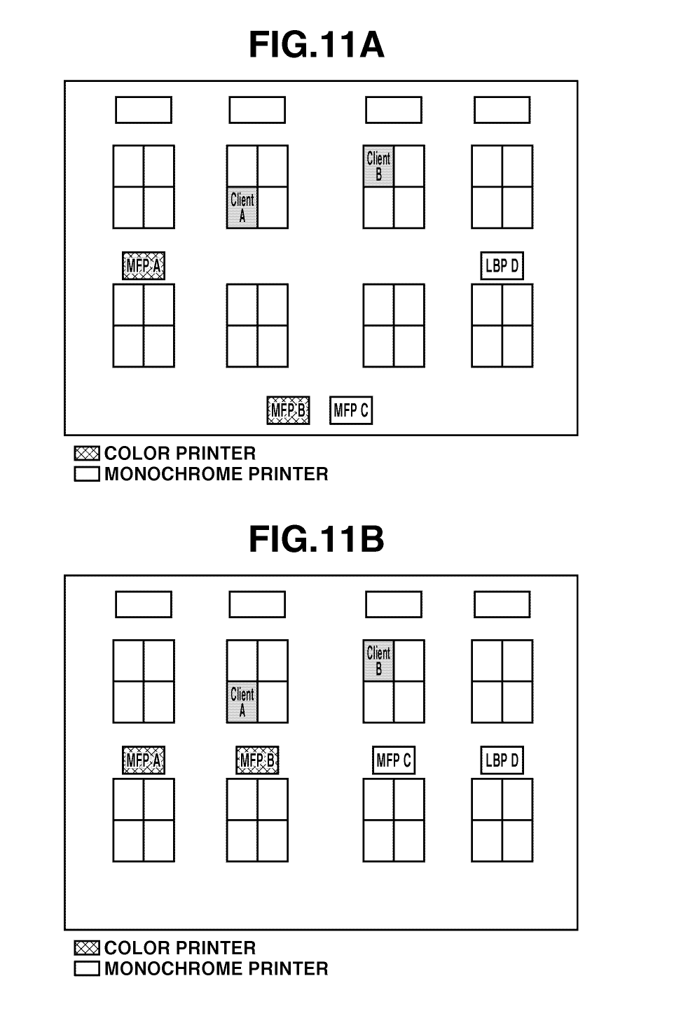

To facilitate understanding of the present exemplary embodiment, FIGS. 11A and 11B illustrate examples of the layout plan view including a plurality of clients and a plurality of printers. The layout illustrated in FIG. 11A corresponds to the printer utilization information list 600a illustrated in FIG. 6A. The layout illustrated in FIG. 11B corresponds to the printer utilization information list 600b illustrated in FIG. 6B.

In the present exemplary embodiment, it is assumed that that the operational environment illustrated in FIG. 6A (see FIG. 11A) has been changed to the operational environment illustrated in FIG. 6B (see FIG. 11B) as a result of calculation of the optimum layout and/or optimization of usage environment. More specifically, it is assumed that the printer utilization information list 600 has been updated from the list illustrated in FIG. 6A to the list illustrated in FIG. 6B. Information relating to respective printers being currently managed, such as IP address (or any other network information) and setup location, has been updated considering the optimum layout.

Regarding the client A, as understood from FIGS. 6A and 6B, the color printer has been changed from “MFP A” to “MFP B” and the monochrome printer has been changed from “MFP C” to “LBP D.” Further, it is assumed that the client A does not require any complicated settings (e.g., staple) and the usage of a BOX for monochrome printing. This is the reason why the printer to be used for the monochrome printing is a laser printer (i.e., “LBP D”), not a multifunction peripheral (MFP).

<Processing Sequence>

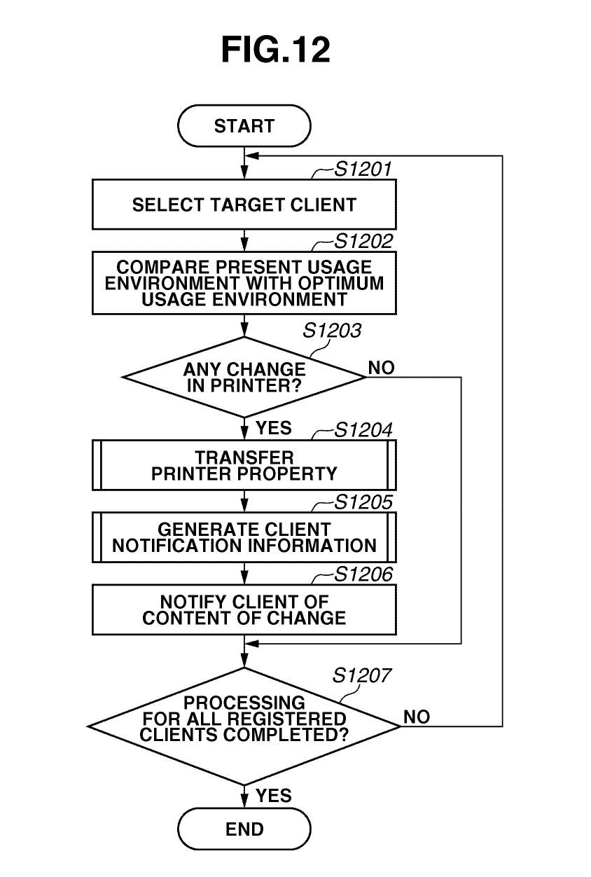

A program relating to processing described referring to the following flowchart is stored in the HD 205 of the information processing apparatus and can be executed by the CPU 200 if it is loaded into the RAM 202. FIG. 12 is a flowchart illustrating an example sequence of the processing that can be performed according to the optimum layout control program 303a of the server 101 when the printer utilization information list 600 is updated (i.e., when the printer utilization information list 600b illustrated in FIG. 6B is generated).

In step S1201, the printer utilization information management unit 5006 selects one of unselected clients among the clients registered in the optimum layout control program 303a of the server 101. More specifically, the clients registered in the optimum layout control program 303a are the clients registered in the printer utilization information list 600 (the client A, the client B, the client C, - - - ). In the following description, the client selected in step S1201 may be referred to as a target client.

Next, in step S1202, the printer utilization information management unit 5006 compares the printer utilization information list 600a currently used (see FIG. 6A) with the optimum printer utilization information list 600b (see FIG. 6B) generated by the printer utilization information management unit 5006.

Next, in step S1203, the printer utilization information management unit 5006 determines whether the comparison result in step S1202 indicates that a printer to be used by the client selected in step S1201 has been changed. As a result of the above-described determination, if it is determined that the printer to be used by the client has been changed (YES in step S1203), then the processing proceeds to step S1204. In FIG. 6B, both the color printer and the monochrome printer have been changed with respect to the client A. Therefore, if in step S1201 the client A is selected, the processing proceeds to step S1204.

On the other hand, if it is determined that the printer to be used by the client has not been changed (NO in step S1203), the processing proceeds to step S1207. In FIG. 6B, both the color printer and the monochrome printer have not been changed with respect to the client C. Therefore, if in step S1201 the client C is selected, the processing proceeds to step S1207.

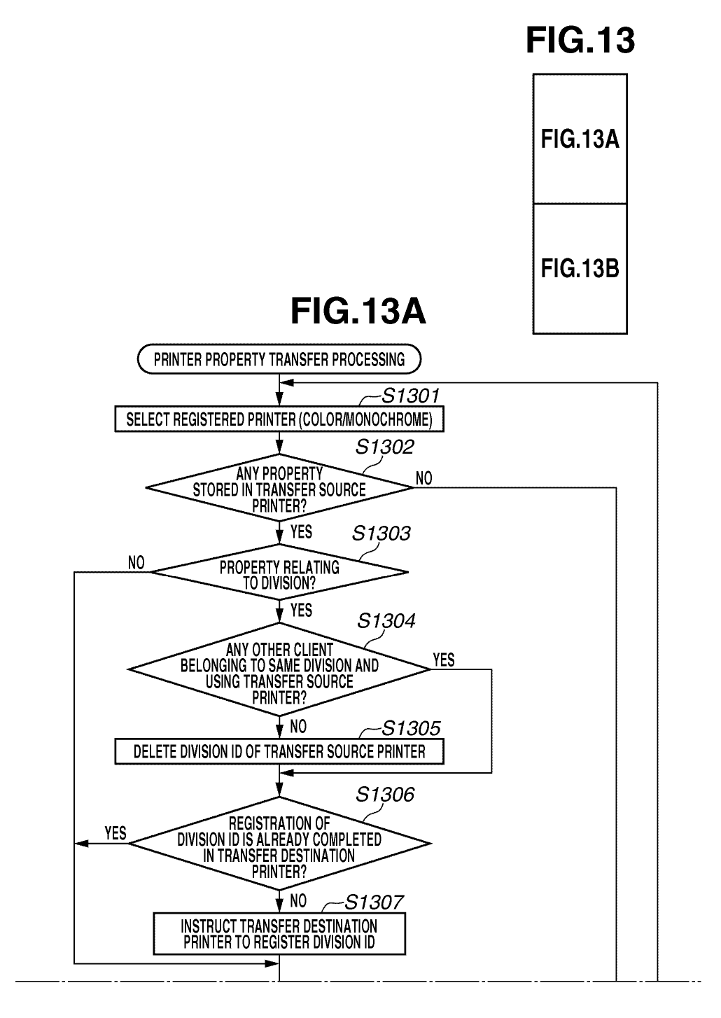

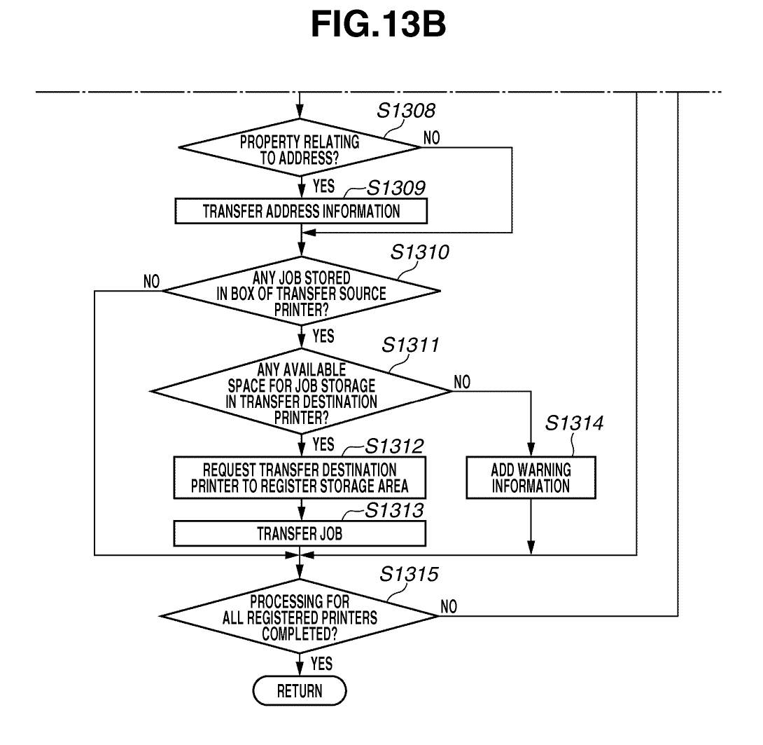

Next, in step S1204, the printer utilization information management unit 5006 executes “printer property transfer” processing to move resource information (property) of the client selected in step S1201 from a currently used printer to a newly used printer. The “printer property transfer” processing is described below in more detail with reference to FIG. 13.

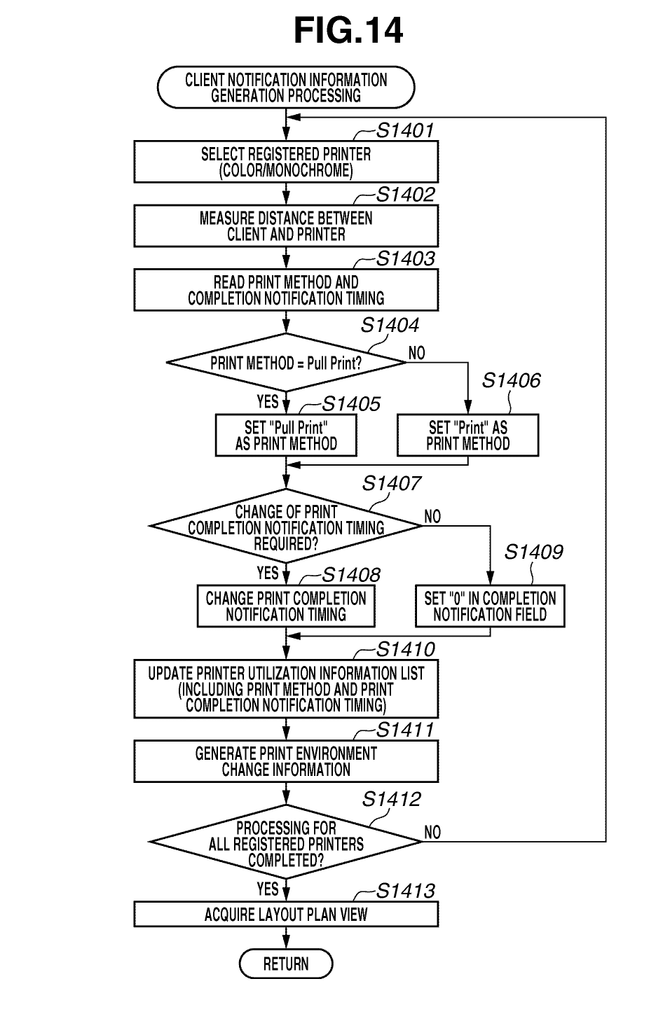

Next, in step S1205, the setup information generation unit 5008 executes “client notification information generation” processing, i.e., processing for generating notification information to notify the client selected in step S1201 of any change in the printer to be used. The “client notification information generation” processing is described below in more detail with reference to FIG. 14.

Next, in step S1206, the notification information generation unit 5009 transmits the notification information generated in step S1205 to the client selected in step S1201. If the client receives the notification information, the user interfaces 900a and 900b illustrated in FIGS. 9A and 9B are displayed by the display unit 5010. FIG. 9A illustrates the user interface 900a that can be displayed for the client A. FIG. 9B illustrates the user interface 900b that can be displayed for the client B.

Next, in step S1207, the printer utilization information management unit 5006 determines whether the processing for all of the clients registered in the optimum layout control program 303a of the server 101 has been completed. As a result of the above-described determination, if it is determined that the processing for all of the registered clients has not been completed (NO in step S1207), then the processing returns to step S1201. The above-described processing of steps S1201 to S1207 is repeated for the next client.

If it is determined that the processing for all of the registered clients has been completed (YES in step S1207), the CPU 200 terminates the processing of the flowchart illustrated in FIG. 12. As described above, in the present exemplary embodiment, if the printer to be used is changed as a result of the optimum layout, information relating to a newly used printer is individually sent to a client.

FIG. 13 is a flowchart illustrating a detailed sequence of the “printer property transfer” processing to be performed in step S1204 of FIG. 12. In the present exemplary embodiment, for example, the printer utilization information management unit 5006 moves the resource information (property) of the client A stored in the BOX of the color printer “MFP A”, such as print job, address information, and division ID, from the color printer “MFP A” (i.e., a transfer source printer) currently used by the client A to the color printer “MFP B” (i.e., a transfer destination printer).

In step S1301, the printer utilization information management unit 5006 selects one of unselected transfer source printers to be used by the client selected in step S1201 (i.e., the target client). In this case, the transfer source printers to be used by the target client are printers registered in the printer utilization information list 600a (see FIG. 6A). More specifically, when the target client is the client A, the transfer source printers are the printers “MFP A” and “MFP C.”

Next, in step S1302, the printer utilization information management unit 5006 confirms the contents of the printer utilization information list 600a, and determines whether the property of the target client is stored in the transfer source printer. More specifically, the printer utilization information management unit 5006 determines whether the BOX number, the address information, and the division ID of the target client are stored in the transfer source printer.

As a result of the above-described determination, if it is determined that the property of the target client is stored in the transfer source printer (YES in step S1302), then the processing proceeds to step S1303. On the other hand, if it is determined that the property of the target client is not stored in the transfer source printer (NO in step S1302), then the processing proceeds to step S1315.

More specifically, the field of the color printer MFP A of the client A includes the BOX number (BOX15), the address information (clientA@˜), and the division ID (0001). Therefore, if in step S1301 the printer “MPF A” is selected, the processing proceeds to step S1303. The field of the monochrome printer (MFP C) of the client A includes the division ID (0001). Therefore, if in step S1301 the printer “MPF C” is selected, the processing proceeds to step S1303.

When the processing proceeds to step S1303, the printer utilization information management unit 5006 determines whether the division ID is included in the property identified in step S1302. As a result of the above-described determination, if it is determined that the division ID is included (YES in step S1303), then the processing proceeds to step S1304. On the other hand, if it is determined that the division ID is not included (NO in step S1303), then the processing proceeds to step S1308 while skipping steps S1304 to S1307.

For example, if in step S1301 the color printer/monochrome printer of the client A is selected, the processing proceeds to step S1304 because the division ID “0001” is stored in the property identified in step S1302.

When the processing proceeds to step S1304, the printer utilization information management unit 5006 inquires the transfer source printer about whether there is any other client who has the division ID identified in step S1303 as a property. Referring to a result of the above-described inquiry, the printer utilization information management unit 5006 determines whether there is any other client who is registered in the transfer source printer as having the division ID identified in step S1303 as a property.

As a result of the above-described determination, if it is determined that there is another client who is registered in the transfer source printer as having the division ID identified in step S1303 as a property (YES in step S1304), then the processing proceeds to step S1306 while skipping step S1305. On the other hand, if it is determined that there is not any client who is registered in the transfer source printer as having the division ID identified in step S1303 as a property (NO in step S1304), then the processing proceeds to step S1305.

For example, if in step S1301 the color printer of the client A is selected, the client C is already registered as a client belonging to the division “0001” (namely, the client continuously uses the color printer “MFP A” as a user belonging to the division “0001”). Therefore, the processing proceeds to step S1306. Similarly, if in step S1301 the monochrome printer of the client A is selected, the processing proceeds to step S1306.

When the processing proceeds to step S1305, the printer utilization information management unit 5006 instructs the transfer source printer selected in step S1301 to delete the registered division ID.

Next, in step S1306, the printer utilization information management unit 5006 determines whether the division ID of the target client (i.e., the division ID identified in step S1303) is already registered in the transfer destination printer. For example, the above-described determination by the printer utilization information management unit 5006 can be performed by referring to the currently used printer utilization information list 600a (see FIG. 6A). Alternatively, the above-described determination by the printer utilization information management unit 5006 can be performed based on a reply to the inquiry transmitted to the transfer destination printer.

As a result of the above-described determination, if it is determined that the division ID of the target client is already registered in the transfer destination printer (YES in step S1306), then the processing proceeds to step S1308 while skipping step S1307. On the other hand, if it is determined that the division ID of the target client is not registered in the transfer destination printer (NO in step S1306), the processing proceeds to step S1307.

For example, if in step S1301 the color printer of the client A is selected, the processing proceeds to step S1307 because the division “0001” is not registered in the color printer “MFP B.” On the other hand, if in step S1301 the monochrome printer of the client A is selected, the processing proceeds to step S1307 because the division “0001” is not registered in the monochrome printer “LBP D.”

Next, in step S1307, the printer utilization information management unit 5006 instructs the transfer destination printer to register the division ID identified in step S1303. For example, if in step S1301 the color printer of the client A is selected, the printer utilization information management unit 5006 instructs the color printer “MFP B” to register the division “0001.”

Next, in step S1308, the printer utilization information management unit 5006 determines whether the address information is included in the property identified in step S1302. As a result of the above-described determination, if it is determined that the address information is included (YES in step S1308), then the processing proceeds to S1309. On the other hand, if it is determined that the address information is not included (NO in step S1308), the processing proceeds to step S1310.

For example, if in step S1301 the color printer of the client A is selected, the processing proceeds to step S1309 because the address information “clientA@˜” is already registered. On the other hand, if in step S1301 the monochrome printer of the client A is selected, the processing proceeds to step S1310 because no address information is registered.

When the processing proceeds to step S1309, the printer utilization information management unit 5006 instructs the transfer source printer (and the transfer destination printer) to move the address information from the transfer source printer to the transfer destination printer. For example, if in step S1301 the color printer of the client A is selected, the address information (clientA@˜) is deleted from the field of the color printer “MFP A” and newly registers to the field of the color printer “MFP B.”

Next, in step S1310, the printer utilization information management unit 5006 determines whether a print job of the target client is stored in the BOX of the transfer source printer. For example, the above-described determination by the printer utilization information management unit 5006 can be performed by referring to the currently used printer utilization information list 600a (see FIG. 6A). Alternatively, the above-described determination by the printer utilization information management unit 5006 can be performed based on a reply to the inquiry transmitted to the transfer destination printer.

As a result of the above-described determination, if it is determined that the print job of the target client is stored in the BOX of the transfer source printer (YES in step S1310), then the processing proceeds to step S1311. On the other hand, if it is determined that the print job of the target client is not stored in the BOX of the transfer source printer (NO in step S1310), then the processing proceeds to step S1315 while skipping steps S1311 to S1314.

For example, if in step S1301 the color printer of the client A is selected, the processing proceeds to step S1311 because a print job is stored in the BOX15 of the color printer “MFP A.” If the monochrome printer of the client A is selected, the processing proceeds to step S1315 because no print job is stored in the BOX.

When the processing proceeds to step S1311, the printer utilization information management unit 5006 determines whether the transfer destination printer has any space area in the BOX that is available to store the print job of the target client. The above-described determination by the printer utilization information management unit 5006 can be performed based on a reply to the inquiry transmitted to the transfer destination printer.

As a result of the above-described determination, if it is determined that there is an available space area in the BOX (YES in step S1311), then the processing proceeds to step S1312. On the other hand, if it is determined that there is not any available space area in the BOX (NO in step S1311), then the processing proceeds to step S1314. For example, if in step S1301 the color printer of the client A is selected, the printer utilization information management unit 5006 confirms whether the color printer “MFP B” has any unregistered BOX. In the present exemplary embodiment, it is assumed that an unregistered BOX10 is present.

When the processing proceeds to step S1312, the printer utilization information management unit 5006 requests the transfer destination printer to register a storage area of the target client in the available BOX of the transfer destination printer. For example, if in step S1301 the color printer of the client A is selected, the color printer “MFP B” registers the BOX10 as a storage area of the client A.

Next, in step S1313, the printer utilization information management unit 5006 instructs the transfer source printer (and the transfer destination printer) to move the print job of the target client from the BOX of the transfer source printer to the BOX of the transfer destination printer. For example, if in step S1301 the color printer of the client A is selected, the job in the BOX15 of the color printer “MFP A” is transferred to the BOX10 of the color printer “MFP B.”

Further, when the processing proceeds to step S1314 from step S1311, the printer utilization information management unit 5006 instructs the notification information generation unit 5009 to add warning information (informing that no job transfer to the transfer destination printer has been performed) to the information to be sent to the target client.

When the processing proceeds to step S1315, the printer utilization information management unit 5006 determines whether the processing for all transfer source printers that can be used by the target client has been completed. As a result of the above-described determination, if it is determined that the processing for all transfer source printers is not completed yet (NO in step S1315), then the processing returns to step S1301. The above-described processing of steps S1301 to S1315 is repeated for the next transfer source printer. On the other hand, if it is determined that the processing for all transfer source printers has been completed (YES in step S1315), the CPU 200 terminates the processing of the flowchart illustrated in FIG. 13.

FIG. 14 is a flowchart illustrating a detailed sequence of the “client notification information generation” processing to be performed in step S1205 illustrated in FIG. 12. In the present exemplary embodiment, the client notification information to be generated for the client A includes, for example, information required to display the user interface 900a (see FIG. 9A), positional information (layout plan) of printers, and the setup information list 800 (see FIG. 8).

In step S1401, the setup information generation unit 5008 selects one of unselected transfer destination printers among the transfer destination printers that can be used by the client selected in step S1201 (i.e., the target client). In the present exemplary embodiment, the transfer destination printers that can be used by the target client are the printers registered in the printer utilization information list 600b (see FIG. 6B). More specifically, when the target client is the client A, the transfer destination printers are the printers “MFP B” and “LBP D.” In the following description, the transfer destination printers selected in step S1401 may be referred to as target printers.

In step S1402, the setup information generation unit 5008 measures the distance between the client selected in step S1201 (i.e., the target client) and the printer with reference to “client-to-printer positional information” stored in the positional information storage unit 5002. For example, if in step S1401 the color printer of the client A is selected, the setup information generation unit 5008 measures the distance between the desk/seat of the client A and the color printer “MFP B.” It is now assumed that, as a measurement result, the distance is “2.”

Further, if in step S1401 the monochrome printer of the client A is selected, the setup information generation unit 5008 measures the distance between the desk/seat of the client A and the monochrome printer “LBP D.” It is now assumed that, as a measurement result, the distance is “9.”

Next, in step S1403, the setup information generation unit 5008 reads an optimum “print method and print completion notification timing” corresponding to the distance measured in step S1402 with reference to the print method list 700 (see FIG. 7) stored in the print method storage unit 5007.

For example, if in step S1401 the color printer of the client A is selected, the distance measured in step S1402 is “2.” Therefore, the optimum print method is “Print” and the optimum print completion notification timing is “-” (no change in the notification timing). On the other hand, if in step S1401 the monochrome printer of the client A is selected, the distance measured in step S1402 is “9.” Therefore, the optimum print method is “Pull Print” and the optimum print completion notification timing is “-.”

Next, in step S1404, the setup information generation unit 5008 determines whether the print method read in step S1403 is Pull Print. As a result of the above-described determination, if it is determined that the print method is Pull Print (YES in step S1404), then the processing proceeds to step S1405. On the other hand, if it is determined that the print method is not Pull Print (i.e., the print method is Print) (NO in step S1404), then the processing proceeds to step S1406.

For example, if in step S1401 the color printer of the client A is selected, the print method corresponding to the distance “2” is “Print.” Therefore, the processing proceeds to step S1406. On the other hand, if in step S1401 the monochrome printer of the client A is selected, the print method corresponding to the distance “9” is “Pull Print.” Therefore, the processing proceeds to step S1405.

When the processing proceeds to step S1405, the setup information generation unit 5008 sets “Pull Print” as the print method of the target printer in the setup information list 800 of the target printer. Then, the processing proceeds to step S1407. For example, if in step S1401 the monochrome printer of the client A is selected, the setup information generation unit 5008 sets “Pull Print” in the “print method” field of the monochrome printer (LBP D).

Further, when the processing proceeds to step S1406, the setup information generation unit 5008 sets “Print” as the print method of the target printer in the setup information list 800 of the target printer. Then, the processing proceeds to step S1407. For example, if in step S1401 the color printer of the client A is selected, the setup information generation unit 5008 sets “Print” in the “print method” field of the color printer (MFP B).

When the processing proceeds to step S1407, the setup information generation unit 5008 determines whether the “print completion notification timing” read in step S1403 causes any change in the notification timing. Namely, the setup information generation unit 5008 determines whether a numerical value representing the time (sec) is set. As a result of the above-described determination, if it is determined that the print completion notification timing having been set causes a change in the notification timing (YES in step S1407), then the processing proceeds to step S1408. On the other hand, if it is determined that the print completion notification timing having been set does not cause any change in the notification timing (NO in step S1407), then the processing proceeds to step S1409.

For example, if in step S1401 the color printer/monochrome printer of the client A is selected, the print completion notification timing is “-” (no change in notification timing). Therefore, the processing proceeds to step S1409.

When the processing proceeds to step S1408, the setup information generation unit 5008 sets the value having been referred to in step S1403 in the “completion notification” field of the target printer in the setup information list 800 of the target client. Then, the processing proceeds to step S1407.

On the other hand, when the processing proceeds to step S1409, the setup information generation unit 5008 sets “0” in the “completion notification” field of the target printer in the setup information list 800 of the target client. In this case, the completion notification is performed upon completion of a printing operation. Then, the processing proceeds to step S1410. For example, if in step S1401 the color printer/monochrome printer of the client A is selected, the setup information generation unit 5008 sets “0” in the “completion notification” field of the color printer/monochrome printer. When the processing proceeds to step S1410, the setup information generation unit 5008 updates the contents (i.e., print method and print completion notification timing) of the printer utilization information list 600b (see FIG. 6B) via the printer utilization information management unit 5006.

Next, in step S1411, the setup information generation unit 5008 generates print environment change information to be notified to the client selected in step S1201. More specifically, the setup information generation unit 5008 generates information indicating printer name, IP address, BOX number, print method, and print completion notification timing as information required when the client displays the user interface 900 (see FIGS. 9A and 9B).

Next, in step S1412, the setup information generation unit 5008 determines whether the processing for all transfer destination printers that can be used by the client selected in step S1201 has been completed. As a result of the above-described determination, if it is determined that the processing for all transfer destination printers is not completed yet (NO in step S1412), then the processing returns to step S1401. The above-described processing of steps S1401 to S1412 is repeated for the next transfer destination printer. On the other hand, if it is determined that the processing for all transfer destination printers has been completed (YES in step S1412), then the processing proceeds to step S1413.

When the processing proceeds to step S1413, the setup information generation unit 5008 acquires from the positional information storage unit 5002 a layout plan view that illustrates a positional relationship among the server, the clients, and the printers.

<Setup Information List (Update List)>

FIG. 8 illustrates an example of the setup information list 800 that can be generated by the setup information generation unit 5008 of the server 101.

Setting information stored in the setup information list 800 can be read by the print control unit 5011 of the client and can be used to change the print environment of the client (i.e., the printer driver settings stored in the printer setting storage unit 601). The setup information list 800 includes a printer name, an IP address of the printer, a BOX number, a print method, and completion notification information.

The setup information list 800 illustrated in FIG. 8 is an example list for the client A, which designates the color printer “MFP B” (whose BOX is BOX10) and the monochrome printer “LBP D” (whose print method is Pull Print).

<Print Method List>

FIG. 7 illustrates an example of the print method list 700 that is stored in the print method storage unit 5007 of the server 101.

The server 101 enables a user using a user interface (not illustrated) to perform settings with respect to the print method and the print completion notification timing on the print method list 700 according to the distance between the client and the printer. The setting information of the print method list 700 can be referred to by the setup information generation unit 5008 to set the print method and the print completion notification timing on the setup information list 800.

<Change Notification User Interface>

FIGS. 9A and 9B illustrate examples of the user interface 900 that can be displayed by the display unit 5010 of the client to notify a user of changes in the print environment. The information to be displayed on the user interface 900 can be generated based on information generated by the notification information generation unit 5009 of the server 101 and transmitted to the client.

It is useful to automatically display the user interfaces 900a and 900b illustrated in FIGS. 9A and 9B in response to the information transmitted from the server 101 or based on a user's operation. In FIGS. 9A and 9B, if a “layout plan” button 901 is pressed, a layout plan view that illustrates a positional relationship among the server, the clients, and the printers can be displayed on the user interface (not illustrated).

Further, if a “setting change” button 902 is pressed, the print control unit 5011 updates the printer driver settings stored in the printer setting storage unit 601 based on the setup information list 800 received from the server 101.

The user interface 900a illustrated in FIG. 9A can be displayed by the client A and the user interface 900b illustrated in FIG. 9B can be displayed by the client B.

<Completion Notification User Interface>

FIG. 10 illustrates an example of the user interface 1000 that can be displayed by the display unit 5010 of the client to notify a user of completion of a printing operation by the printer.

The print control unit 5011 of the client constantly monitors the printing status of the printer and displays the user interface 1000 at the time when the completion of a printing operation by the printer is detected. If a numerical value representing the print completion notification timing (i.e., notification timing) is set in the “completion notification” field of the setup information list 800, the print completion notification can be performed at the timing having been set.

Further, in a case where the client does not perform printing according to the settings notified by the notification information generation unit 5009 of the server 101, a warning message instructing to perform printing as designated (set) by the notified contents is displayed together with a printing result. For example, if the client A uses the monochrome printer “MFP C”, a warning message designating the monochrome printer “LBP D” as a printer to be used in printing is displayed.

In FIG. 10, if a “layout plan” button 1001 is pressed, a layout plan view that illustrates a positional relationship among the server, the clients, and the printers can be displayed on the user interface (not illustrated). Further, if a “setting change” button 1002 is pressed, the print control unit 5011 updates the printer driver settings stored in the printer setting storage unit 601 based on the setup information list 800 received from the server 101.

As described above, in the present exemplary embodiment, if an optimum layout of a plurality of printers is calculated and the printer utilization information list 600 is updated, a determination is made for each client to check whether the printer to be used by each client has been changed. Then, if the printer to be used by a client has been changed, the information relating to the client stored in a currently used printer is moved to a newly used printer.

Further, notification information relating to the newly used printer (i.e., information including the printer to be used by the client and the print method of the client) is generated for the client and transmitted to the client. Then, each client displays print environment change information (and automatically updates the print environment) based on the notification information generated for each client by the notification information generation unit 5009 of the server 101.

Accordingly, the present exemplary embodiment can prompt a user of each client to perform an operation according to an optimum layout of the printers, and enables the user of each client to perform a printing operation in the optimum print environment. Therefore, according to the present exemplary embodiment, the printers can be efficiently used in the entire print environment.

In the above-described exemplary embodiment, the display unit 5010 of the client displays the user interfaces 900a and 900b (see FIGS. 9A and 9B) based on the information generated by the notification information generation unit 5009 of the server 101 to notify users of changes in the usage environment.

However, as another employable method, it is useful that the notification information generation unit 5009 of the server 101 sends an electronic mail notifying a change, if occurs in the usage environment, to the client. In short, any other method capable of notifying each client of a change in the usage environment can be employed.

Further, in the present exemplary embodiment, the print control unit 5011 of the client updates the printer driver settings based on the setup information list 800 generated by the setup information generation unit 5008 of the server 101. However, for example, it is useful that the setup information generation unit 5008 of the server 101 generates an update program and each client executes the update program to update the printer driver settings.

The above-described exemplary embodiments are mere examples in embodying the present invention. The technical scope of the present invention should not be narrowly interpreted based on the disclosure of the exemplary embodiments described above. In other words, the present invention can be modified in various ways without departing from the technical thought or essential features thereof.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-283346 filed Dec. 14, 2009, which is hereby incorporated by reference herein in its entirety.

What is claimed is:

1. An information distribution apparatus that can communicate with information processing apparatuses of a plurality of clients who can use a plurality of image forming apparatuses, the information distribution apparatus comprising:
a storage unit configured to store information relating to the plurality of image forming apparatuses;
an updating unit configured to update the information relating to the plurality of image forming apparatuses stored in the storage unit according to an optimum layout of the plurality of image forming apparatuses obtained based on history information collected from the plurality of image forming apparatuses;
an analyzing unit configured to analyze an image forming apparatus to be used by each of the plurality of clients according to the optimum layout of the plurality of image forming apparatuses obtained based on the history information collected from the plurality of image forming apparatuses;
a generation unit configured to generate, as an analysis result according to the optimum layout, notification information including information relating to the image forming apparatus to be used by each of the plurality of clients and a print method of the client corresponding to the image forming apparatus; and
a notification unit configured to send the notification information generated by the generation unit to each of the plurality of information processing apparatuses.

2. The information distribution apparatus according to claim 1, wherein the information relating to the image forming apparatus includes at least one of an IP address of the image forming apparatus and a setup location of the image forming apparatus.

3. The information distribution apparatus according to claim 1, wherein the notification information includes information instructing to use Pull Print as a print method.

4. The information distribution apparatus according to claim 1, wherein the generation unit is configured to generate notification information including information relating to completion notification timing of processing performed by the image forming apparatus based on a request from the information processing apparatus.

5. The information distribution apparatus according to claim 1, wherein the notification unit is configured to send, in addition to the notification information, information required in confirmation of the layout of the plurality of image forming apparatuses according to the optimum layout.

6. The information distribution apparatus according to claim 1, wherein the information processing apparatus changes settings relating to usage of the image forming apparatus to be used, which is analyzed by the analyzing unit, based on the notification information sent from the notification unit.

7. The information distribution apparatus according to claim 1, further comprising an instruction unit configured to instruct to transfer resource information between a plurality of image forming apparatuses for respective clients managed by each of the plurality of image forming apparatuses according to the optimum layout of the plurality of image forming apparatuses obtained based on the history information collected from the plurality of image forming apparatuses.

8. The information distribution apparatus according to claim 7, wherein the resource information includes at least one of BOX number, address information, and division ID.

9. An information processing apparatus that can communicate with an information distribution apparatus, the information processing apparatus comprising:
a reception unit configured to receive, as a result of analysis on an optimum layout of a plurality of image forming apparatuses that can be used by a client of the information processing apparatus, a notification including information relating to an image forming apparatus to be used and a print method of the client corresponding to the image forming apparatus; and
a display unit configured to perform a display prompting a user to use the image forming apparatus designated in the notification received by the reception unit according to the designated print method, if the image forming apparatus is used according to contents different from the notification received by the reception unit.

10. The information processing apparatus according to claim 9, wherein the display unit is configured to perform a display prompting a user to use the image forming apparatus designated in the notification received by the reception unit according to the designated print method, as a completion notification when the image forming apparatus is used.

11. A method for controlling an information distribution apparatus that can communicate with information processing apparatuses of a plurality of clients who can use a plurality of image forming apparatuses, the method comprising:
storing information relating to the plurality of image forming apparatuses;
updating the stored information relating to the plurality of image forming apparatuses according to an optimum layout of the plurality of image forming apparatuses obtained based on history information collected from the plurality of image forming apparatuses;
analyzing an image forming apparatus to be used by each of the plurality of clients according to the optimum layout of the plurality of image forming apparatuses obtained based on the history information collected from the plurality of image forming apparatuses;
generating, as an analysis result according to the optimum layout, notification information including information relating to the image forming apparatus to be used by each of the plurality of clients and a print method of the client corresponding to the image forming apparatus; and
sending the generated notification information to each of the plurality of information processing apparatuses.

12. The information distribution apparatus control method according to claim 11, wherein the information relating to the image forming apparatus includes at least one of an IP address of the image forming apparatus and a setup location of the image forming apparatus.

13. The information distribution apparatus control method according to claim 11, wherein the notification information includes information instructing to use Pull Print as a print method.

14. The information distribution apparatus control method according to claim 11, wherein the generated notification information includes information relating to completion notification timing of processing performed by the image forming apparatus based on a request from the information processing apparatus.

15. The information distribution apparatus control method according to claim 11, wherein information required in confirmation of the layout of the plurality of image forming apparatuses according to the optimum layout is sent together with the notification information.

16. The information distribution apparatus control method according to claim 11, wherein the information processing apparatus changes settings relating to usage of the image forming apparatus, which is analyzed as an image forming apparatus to be used, based on the notification information.

17. The information distribution apparatus control method according to claim 11, further comprising instructing to transfer resource information between a plurality of image forming apparatuses for respective clients managed by each of the plurality of image forming apparatuses according to the optimum layout of the plurality of image forming apparatuses obtained based on the history information collected from the plurality of image forming apparatuses.

18. The information distribution apparatus control method according to claim 17, wherein the resource information includes at least one of BOX number, address information, and division ID.

19. A method for controlling an information processing apparatus that can communicate with an information distribution apparatus, the method comprising:
receiving, as a result of analysis on an optimum layout of a plurality of image forming apparatuses that can be used by a client of the information processing apparatus, a notification including information relating to an image forming apparatus to be used and a print method of the client corresponding to the image forming apparatus; and
performing a display prompting a user to use the image forming apparatus designated in the received notification according to the designated print method, if the image forming apparatus is used according to contents different from the received notification.

20. The information processing apparatus control method according to claim 19, wherein the display prompting a user to use the image forming apparatus designated in the received notification according to the designated print method is performed as a completion notification when the image forming apparatus is used.

21. A computer-readable storage medium storing a computer program that causes a computer to control an information distribution apparatus that can communicate with information processing apparatuses of a plurality of clients who can use a plurality of image forming apparatuses, the computer program comprising:
computer-executable instructions for storing information relating to the plurality of image forming apparatuses;
computer-executable instructions for updating the stored information relating to the plurality of image forming apparatuses according to an optimum layout of the plurality of image forming apparatuses obtained based on history information collected from the plurality of image forming apparatuses;
computer-executable instructions for analyzing an image forming apparatus to be used by each of the plurality of clients according to the optimum layout of the plurality of image forming apparatuses obtained based on the history information collected from the plurality of image forming apparatuses;
computer-executable instructions for generating, as an analysis result according to the optimum layout, notification information including information relating to the image forming apparatus to be used by each of the plurality of clients and a print method of the client corresponding to the image forming apparatus; and
computer-executable instructions for sending the generated notification information to each of the plurality of information processing apparatuses.

22. A computer-readable storage medium storing a computer program that causes a computer to control an information processing apparatus that can communicate with an information distribution apparatus, the computer program comprising:
computer-executable instructions for receiving, as a result of analysis on an optimum layout of a plurality of image forming apparatuses that can be used by a client of the information processing apparatus, a notification including information relating to an image forming apparatus to be used and a print method of the client corresponding to the image forming apparatus; and
computer-executable instructions for performing a display prompting a user to use the image forming apparatus designated in the received notification according to the designated print method, if the image forming apparatus is used according to contents different from the received notification.
